(19) United States
(12) Patent Application Publication
(10) Pub. No.: US 2003/0096925 A1
(43) Pub. Date: May 22, 2003

(54) Alkyllithium formulations with improved thermal stability and processes for making the same

(75) Inventors: Thorsten Werner Brockmann, Hilton Head, SC (US); Vijay C. Mehta, Gastonia, NC (US)

Correspondence Address: MYERS BIGEL SIBLEY & SAJOVEC, PO BOX 37428, RALEIGH, NC, 27627, US

(73) Assignee: FMC Corporation

(21) Appl. No.: 10/045,960

(22) Filed: Oct. 24, 2001

(51) Int. Cl. C08F 4/44; C07F 1/02; C07F 3/02

(52) U.S. Cl. 526/123.1; 260/665 R; 260/665 G

(57) ABSTRACT

Formulations of alkyllithium species having improved thermal stability are provided. The compositions include one or more alkyllithium compounds and one or more additives. The additive includes one or more organometallic compounds or precursors thereof capable of forming ate complexes with alkyllithiums.

### FIELD OF THE INVENTION

This invention relates to alkyllithium compositions, and more particularly to thermally stable alkyllithium compositions and processes for making the same.

### BACKGROUND OF THE INVENTION

Alkyllithium compounds have found increasing use as anionic initiators in polymer chemistry, and as reagents in organic synthesis. Typically, alkyllithium compounds are supplied commercially in hydrocarbon solution, such as hexane or cyclohexane.

Alkyllithium compounds decompose by thermal elimination of lithium hydride, with concurrent formation of the corresponding olefin. The decomposition of normal butyllithium is illustrated in equation I.

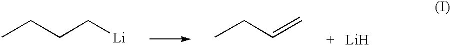

The lithium hydride is virtually insoluble in this medium, and precipitates from solution. This precipitation can cause pluggage of butyllithium pipes and transfer lines. Further, safety and environmental problems can arise when the clogged lines are cleared. In addition, the co-product of this degradation, 1-butene, is a flammable gas. Thus, the thermal stability of these alkyllithium compounds is of importance, particularly on a commercial scale.

Several factors influence the rate of thermal degradation, including: the identity of the alkyllithium compound, the concentration of the solution, the identity of the solvent, the temperature, and the nature of the impurities present, particularly alkoxides. The alkyllithium decomposition rate can be measured by the decline in the active carbon-lithium species, as determined by titration. Various titrametric methods are collected in B. J. Wakefield, Organolithium Methods, Academic Press, New York, 1988, 16-18. Thermal decomposition data for normal butyllithium (n-C₄H₉Li) and secondary butyllithium (s-C₄H₉Li) in hydrocarbon solvents is collected in the table below. The decomposition rate is shown to increase with an increase in storage temperature, and an increase in the concentration of the alkyllithium. Further, secondary butyllithium is less stable than normal butyllithium at all temperatures. For additional discussion of the thermal decomposition of alkyllithium reagents, see M. Schlosser, Organometallics in Synthesis, A Manual, John Wiley, New York, 1994, 171-173.

### Decomposition Rates (% Material Lost per Day)

| | | | s-C₄H₉-Li |
|---|---|---|---|
| Storage | n-C₄H₉-Li | n-C₄H₉-Li | 10-12% in |
| Temperature (° C.) | 15-20% in hexane | 90% in hexane | isopentane |
| 0 | 0.00001 | 0.0005 | 0.003 |
| 5 | 0.0002 | 0.0011 | 0.006 |
| 10 | 0.0004 | 0.0025 | 0.012 |
| 20 | 0.0018 | 0.013 | 0.047 |
| 35 | 0.017 | 0.11 | 0.32 |

The addition of a Lewis base enhances the rate of decomposition of an alkyllithium compound. For instance, n-butyllithium is completely decomposed in tetrahydrofuran at room temperature within two hours, see H. Gilman and B. J. Gaj, J. Org. Chem., 22, 1165 (1957). The alkyllithium compound can also react with the Lewis base; this reaction is illustrated in equation II for the interaction of n-butyllithium with tetrahydrofuran.

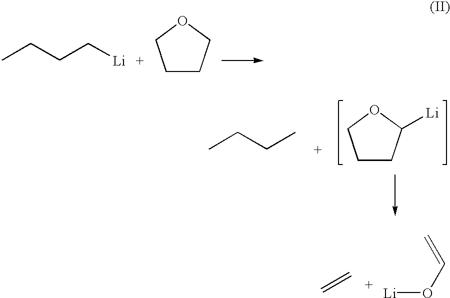

The tetrahydrofuran is initially deprotonated with the n-butyllithium, alpha to the oxygen atom, to afford n-butane. The metallated tetrahydrofuran then decomposes to ethylene and the enolate of acetaldehyde. Similar decomposition pathways exist for the interaction of other alkyllithium species with various Lewis bases. For instance, the half life of t-butyllithium in dimethoxyethane is only eleven minutes at −70° C. See J. J. Fitt and H. W. Gschwend, J. Org. Chem., 49, 209, (1984). For a further discussion of the interaction of alkyllithium compounds with Lewis bases, see H. L. Hsieh and R. P. Quirk, Anionic Polymerization, Marcel Dekker, Inc., New York, 1996. 102-103.

U.S. Pat. No. 6,103,846 to Willis et al. is directed to a process of anionic polymerization using protected functionalized initiators of the structure R¹R²R³—Si—O-A-B, wherein each R¹, R², and R³ is independently selected from saturated and unsaturated aliphatic and aromatic radicals, A is a hydrocarbon bridging group containing from 1 to 25 carbon atoms, and B is an alkali metal, such as lithium. More particularly, the Willis et al. patent is directed to a polymerization process conducted in the presence of termination inhibitors selected to inhibit the reactivity of such protected functionalized initiators towards undesired side reactions. The inhibitors include metal alkyl compounds.

Willis et al. state at Column 5, lines 20 to 23, that “[i]t is unlikely that levels below one inhibitor per 10 C-Li chain ends (Metal Alkyl/C-Li Center >0.1) give a measurable level of inhibition of the side reaction with the Si—O centers.” Thus the Willis et al. patent indicates that at least 10 mol percent metal alkyl is necessary to achieve the desired reactivity inhibition of the living end with the Si—O bond of the protecting group. Preferred levels of the alkyl metal are stated to range from 50 mol % to 100 mol %, and the examples demonstrate the use of 100 mol % triethylaluminum (TEA).

Hsieh and Quirk discuss the effect of organometallic compounds of different metals with alkyllithiums. See pages 143-146 of H. L. Hsieh and R. P. Quirk, Anionic Polymerization, Marcel Dekker, Inc., New York, 1996. For example, addition of increasing amounts of dibutylmagnesium to a constant amount of sec-butyllithium in cyclohexane was reported to reduce the rate of styrene or butadiene polymerization and decrease molecular weight without significantly broadening molecular weight distribution or changing the polybutadiene microstructure. See page 145 of Hsieh and Quirk, referencing H. L Hsieh and I. W. Wang, Macromolecules, 19, 299 (1986). Thus the dibutylmagnesium slows, or inhibits, polymerization rates to better control polymer molecular weight distribution and microstructure. Generally, dibutylmagnesium is used in an amount effective to inhibit the polymerization rate to achieve this effect, or about a 1:1 molar ratio (or 100 mol % dibutylmagnesium). Even for complexes of alkyllithiums and diethylzinc, reported to increase the rate of initiation for polymerization of butadiene and styrene, diethylzinc is generally used in 1:1 molar ratios, or 100 molar %.

This inhibiting effect of an organometallic compound, such as triethylaluminum, upon polymerization reactions is illustrated by U.S. Pat. No. 5,514,753 to Ozawa et al. The Ozawa et al. patent is directed to a process for preparing block copolymers that include a non-polar block (such as a polybutadiene or polystyrene block) and a polar block (such as a poly t-butylmethacrylate block). In Ozawa et al., a non-polar block is prepared by anionically polymerizing a non-polar monomer using a suitable initiator such as butyllithium. The resultant non-polar block with a living lithium end is then reacted with a polar monomer in the presence of an organic compound containing a main group element of II or III group metals, such as triethylaluminum.

Adding triethylaluminum or other suitable agent is stated to lower the reactivity of the carbanion at the living polymer end towards a polar monomer to provide the desired polymer microstructure. The amount of organic compound used is stated to range from about 0.5 to 10 mol equivalents per 1 mol equivalent of anionic polymerization initiator (or about 50 to 1000 mol %). See Column 6, lines 19-21. As further stated in the Ozawa et al. patent, “[i]f the amount is less than 0.5 mol equivalent per 1 mol of initiator, the effect might not be significant . . . ” See Column 6, lines 23-25. Thus, again the art demonstrates that such organometallic compounds are used in relatively large mole percentages in order to inhibit reactivity of the carbanion, and thus slow down polymerization rates.

### SUMMARY OF THE INVENTION

The present invention provides compositions of alkyllithium compounds that exhibit improved thermal stability as compared to prior alkyllithium compositions. The alkyllithium compositions include one or more thermal stabilizing organometallic additives. Surprisingly the inventors have found that relatively small amounts of the organometallic additive can provide unexpected benefits such as improved thermal stability, increased yields of the alkyllithium product, and the like. Yet the presence of the organometallic compound does not significantly adversely compromise the reactivity of the alkyllithium species, for example, as anionic polymerization initiators.

The organometallic compounds are generally present in the compositions of the invention in an amount sufficient to thermally stabilize the alkyllithium species without significantly inhibiting or compromising the reactivity of the alkyllithium species. Advantageously the organometallic compound is present in an amount less than about 10 mol percent (less than 0.1 molar equivalent), based on the amount of lithiated species present, although significantly lower levels can be effective in thermally stabilizing the alkyllithium species.

The thermal stabilizing organometallic additives include organometallic compounds that are capable of forming ate complexes with an alkyllithium. Exemplary organometallic compounds that are capable of forming an ate complex with an alkyllithium can be represented by the general formula MetR′ₙ, wherein:

Met is a metal, preferably selected from Group IIA, Group IIB, and Group IIIB of the Periodic Table of Elements;

each R′ is independently selected from linear or branched C1-C20 aliphatic hydrocarbons, C2-C20 cycloaliphatic hydrocarbons, C5-C20 aromatic hydrocarbons, and mixtures thereof; and

n is the valence of Met. One particularly advantageous thermal stabilizing additive is dibutylmagnesium.

The resultant compositions exhibit improved thermal stability and thus reduced alkyllithium degradation. As a result the compositions of the invention can have reduced amounts of insoluble lithium hydride and/or increased amounts of active carbon-lithium species, as compared to identical solutions without an additive. This in turn can minimize many of the problems associated with the use of alkyllithium compositions, such as clogging of pipe and transfer lines, environmental and safety concerns, and the like. In addition, the compositions of the invention can provide cost savings associated with shipping and storage. For example, composition concentrations can be increased without concurrent increase of alkyllithium degradation. Also, the compositions can be more readily shipped and stored without requiring refrigeration. These formulations can also be prepared in higher yields than previously obtained.

As discussed above, U.S. Pat. No. 6,103,846 to Willis et al. states that greater than 10 mole % of the metal alkyl is required to inhibit the reactivity of a polymer. In particular, the Willis et al. patent states that greater than 10 mole % polymerization termination inhibitor is required to inhibit terminating reactions resulting from the reaction of the alkali metal living end of the polymer chain with the —Si—O— bond on the protected end of the polymer chain. Thus, based on the teachings of the Willis et al. patent, it is reasonable to assume that one would not observe polymerization termination inhibition resulting from alkali metal attack of the silicon bond using less than 10 mole % of the metal alkyls described therein. Surprisingly, however, the inventors have found that less than 10 mole % of an organometallic agent can thermally stabilize a monomeric system.

The present invention not only uses less than 10 mole % of the agent. The present invention is also directed to a different system than that described by Willis et al., namely a monomeric system and not a polymeric system. One skilled in the art will appreciate the differences between monomeric systems and polymeric systems, including the different reactivities of such systems.

### DETAILED DESCRIPTION OF THE INVENTION

The novel stabilized compositions of the invention include one or more alkyllithium species and one or more organometallic additives capable of thermally stabilizing the composition. Alkyllithium thermal stabilizing organometallic compounds in accordance with the present invention include organometailic compounds capable of interacting with the alkyllithium to form an ate complex therewith. Advantageously the organometallic compounds are soluble in hydrocarbon solvents, but this is not required.

Organometallic compounds that are capable of forming an ate complex with an alkyllithium can be represented by the general formula MetR′ₙ, wherein:

Met is a metal, preferably selected from Group IIA, Group IIB, and Group IIIB of the Periodic Table of Elements;

each R′ is independently selected from linear or branched C1-C20 aliphatic hydrocarbons, C2-C20 cycloaliphatic hydrocarbons, C5-C20 aromatic hydrocarbons, and mixtures thereof; and

n is the valence of Met.

Thus the organometallic can be described as a compound of the formula M¹R²⁰R²¹ or M²R²³R²⁴R²⁵ wherein M¹ is an element of Group IIA or Group IIB, M² is an element of Group IIB, and each R²⁰, R²¹, R²³, R²⁴, and R²⁵ is independently selected from the group consisting of linear or branched C1-C20 aliphatic hydrocarbons, C2-C20 cycloaliphatic hydrocarbons, C5-C20 aromatic hydrocarbons, and mixtures thereof. The Group IIA and IIB elements include beryllium, magnesium, calcium, strontium, barium, radium, zinc, cadmium, and mercury. The Group IIB elements include boron, aluminum, gallium, indium, and thallium. Exemplary organometallic compounds include without limitation diethylmagnesium, diisopropylmagnesium, dibutylmagnesium, dicyclohexylmagnesium, diphenylmagnesium, diethylzinc, dibutylzinc, diphenyl zinc, triethylaluminum, tripropylaluminum, triisopropylaluminum, tributylaluminum, trioctylaluminum, trimethylboron, triethylboron, and tributylboron and the like and mixtures thereof. As used herein, the term “butyl” includes n-butyl, sec-butyl and iso-butyl. Also as used herein the term linear or branched aliphatic hydrocarbons, cycloaliphatic hydrocarbons and aromatic hydrocarbons include functionalized hydrocarbons, including one or more sulfur, nitrogen and/or oxygen atoms.

These and other additives within the scope of this invention are commercially available or can be synthesized using commercially available starting materials using known procedures.

Alkyllithium species include compounds of the formula R—Li, wherein R represents a linear or branched aliphatic, cycloaliphatic, or aryl substituted aliphatic radical. Preferably R is an alkyl or substituted alkyl group of 1-12 carbon atoms. Alkyllithium compounds also include dilithium compounds as known in the art. See, for example, U.S. Pat. Nos. 5,393,843 and 5,405,911. Dilithium compounds can be prepared by the reaction of two equivalents of an alkyllithium reagent, such as sec-butyllithium, with a compound having at least two independently polymerized vinyl groups, such as isomeric divinylbenzenes or isomeric diisopropenylbenzenes.

Examples of alkyllithium compounds of the composition include, but are not limited to, methyllithium, ethyllithium, n-propyllithium, 2-propyllithium, n-butyllithium, s-butyllithium, t-butyllithium, n-hexyllithium, 1-octyllithium, 2-ethylhexyllithium, and the like and mixtures thereof.

The increased thermal stability of these formulations can be manifested in higher carbon bound lithium values, as measured by titration, versus the identical formulation without the additive. In addition, minimal amounts of hazardous by-products are typically produced in these formulations, due to the increased thermal stability. For example, these stabilized formulations can be clear solutions (very low turbidity), free of suspended lithium hydride. The corresponding untreated formulations are typically opaque, with significant quantities of lithium hydride suspended. The turbidity of the untreated solutions can be significantly higher than the stabilized formulations, as determined on a nephelometer.

As used herein the term “thermal stability” of the compositions of the invention refers to compositions having higher carbon bound lithium values (or increased active carbon-lithium species) as compared to formulations without an additive. Preferably the compositions of the invention have carbon bound lithium values of at least about 90% and higher, determined using titration, after the compositions are stored for 5 days at 40° C. Alternatively “thermal stability” refers to compositions having decreased lithium hydride precipitation. For example, secondary butyllithium compositions of the invention with additive can measure less than about 100 ntu (nephelometer tubidity units) determined using a nephelometer after being stored for 24 hours at 40° C., in contrast to an identical secondary butyllithium formulation without additive (which exhibits about 1668 ntu after being stored at 40° C. for 24 hours).

It is believed that these additives interact with the alkyllithium compounds, as can be determined by proton and/or carbon nuclear magnetic resonance (NMR). Although not wishing to be bound by any explanation of the invention, it is currently believed that these interactions stabilize the alkyllithium species to prevent or minimize thermal degradation. However, the interactions are reversible, and thus still allow the alkyllithium species to perform the desired chemistry, such as deprotonate an organic acid, or initiate an anionic polymerization. Thus, the additives can be generally be described as compounds which are capable of reversibly interacting with the alkyllithium species in a hydrocarbon solvent system to stabilize the alkyllithium species and to allow the alkyllithium species to perform the desired chemistry in downstream applications.

The compositions of this invention may be prepared in several ways. The preferred technique depends on various factors such as but not limited to the identity of the alkyllithium species and the identity of the additive(s). Generally one or more organometallic compounds and/or precursor(s) thereof can be added to the composition prior to, during or after the synthesis of the alkyllithium species. For example, an organometallic additive and/or its precursor may be added during the synthesis of the alkyllithium species. In this mode, the organometallic compound and/or its precursor can be added to solvent prior to or substantially simultaneously with the addition of an alkyllithium precursor halide. The organometallic compound and/or its precursor may also be mixed with the alkyllithium precursor halide, and thus added substantially simultaneously to the reactor with the alkyllithium precursor halide. The organometallic compound and/or its precursor can alternatively be added to the reaction mixture after addition of an alkyllithium precursor halide. Still further, the organometallic compound and/or its precursor can be introduced into a lithium dispersion and thus added to a reaction mixture substantially simultaneously with the addition of the lithium dispersion. In another mode, the organometallic compound and/or its precursor may be added to the formulation after the synthesis of the alkyllithium is substantially complete, either prior to or after filtration to remove the by-product lithium halide.

As a non-limiting example, in one embodiment, an organometallic compound precursor, such as a metal precursor like magnesium metal, can be added to solvent in a reactor prior to or substantially simultaneously with the addition of the alkyllithium precursor halide. As another non-limiting example, an active metal halide or alkoxide can be added to the alkyllithium composition, again prior to, during or after the synthesis reaction. Typically the active metal halide or alkoxide precursor is added to the composition after the synthesis reaction, either prior to or after filtration. The active metal halide or alkoxide can be represented generally by the formula MeXₙ, wherein Me is the metal, X is halide or C1-C10 alkoxide, and n is the valence of the metal.

Unexpectedly, it was discovered that the yield of the alkyllithium species and the carbon bound lithium value of the resultant alkyllithium can be higher when certain additives are present during the synthesis. This can be demonstrated by increased carbon-bound lithium values and/or yields with the addition of the additives to the compositions.

The organometallic compound is present in an amount sufficient to thermally stabilize the alkyllithium species without significantly compromising or inhibiting the reactivity of the alkyllithium species. The quantity of the additive required depends on several factors, including without limitation the identity of the alkyllithium species, the concentration of the alkyllithium species, the solvent, the identity of the additive(s), and the storage temperature. In general, the organometallic additives are employed in an amount less than about 10 mol %, based on the amount of alkyllithium species present (or less than about 0.1 molar equivalents). As little as about 0.1 mol % (or 0.001 mol equivalents) additive, based on the amount of alkyllithium species, may be employed. Even amounts of the additive as low as 0.001 mol % (or 0.00001 mol equivalents) can be effective to thermally stabilize the compositions of the invention. Advantageously the additive is present in an amount ranging from about 1 to about 7 mol % (about 0.01 to about 0.07 equivalents), based on the amount of alkyllithium species present.

The inert solvent employed in the formulation is preferably a non-polar solvent such as a hydrocarbon. Inert hydrocarbon solvents useful in practicing this invention include but are not limited to inert liquid alkanes, cycloalkanes and aromatic solvents such as alkanes and cycloalkanes containing five to ten carbon atoms such as pentane, hexane, cyclohexane, methylcyclohexane, heptane, methylcycloheptane, octane, decane and so forth and aromatic solvents containing six to ten carbon atoms such as benzene, toluene, ethylbenzene, p-xylene, m-xylene, o-xylene, n-propylbenzene, isopropylbenzene, n-butylbenzene, and the like, as well as mixtures of such solvents.

The present invention will be further illustrated by the following non-limiting example.

### Preparation and Stabilization of s-Butyllithium

A 500 mL Morton flask was equipped with a mechanical stirrer, a Claisen adapter fitted with a dry ice condenser and gas inlet, and a 100 milliliter pressure-equalizing dropping funnel. This apparatus was dried in an oven overnight at 125° C., assembled hot, and allowed to cool to room temperature in a stream of argon. Lithium metal dispersion was washed free of mineral oil with hexane (2×100 ml), and pentane (1×100 ml). The resultant lithium dispersion was dried in a stream of argon, weighed, 25.9 grams (3.73 moles) and transferred to the reaction flask with cyclohexane (171 g). The mechanical stirrer was set at an agitation rate of 500 RPMs, and the reaction mixture was heated to 40° C. with a heating mantle. The heat source was removed. The dropping funnel was charged with s-butylchloride (165.5 g, 1.79 mol). The precursor was added dropwise, at an approximate feed rate of 1.63 ml/min. The reaction mixture was maintained at 40° C. with a dry ice/hexane bath. The reaction was allowed to stir for an additional one hour and maintained at a temperature of 60° C. with a heating mantle. The reaction mixture was then allowed to cool to room temperature and transferred to a medium porosity pressure filter. The lithium muds were washed with cyclohexane (1×452 gms) to afford 698.9 gms (81.4% yield based on % active) of the title compound in cyclohexane.

The stability of s-butyllithium was performed in a separate experiment. The prepared s-butyllithium was separated into two different lots. Lot 1 contained 13.3 wt % s-butyllithium (80 g). Lot 2 contained 13.3 wt % s-butyllithium (61.65 g) and was treated with 14.0 wt % dibutylmagnesium (6.5 g). The table below shows the difference in activity after the samples were aged for a period of 39 days at 40° C.

| | | Lot 2 |
|---|---|---|
| | Lot 1 (control) | (with 5 mol % DBM) |
| Initial concentration | 2.15 | 2.19 |
| Active (mol/kg) | | |
| Aging after 39 days at 40° C. | 0.56 | 0.93 |
| Active (mol/kg) | | |

The foregoing example is illustrative of the present invention and are not to be construed as limiting thereof. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An alkyllithium composition having enhanced thermal stability, comprising:
at least one alkyllithium compound; and
at least one organometallic compound capable of forming an ate complex with said alkyllithium compound in an amount sufficient to impart thermal stability to the composition without significantly inhibiting the reactivity of the alkyllithium species.

2. The composition of claim 1, wherein said composition has a carbon bound lithium value of at least about 90%, determined using titration, after being stored for 5 days at 40° C.

3. The composition of claim 1, wherein said organometallic compound is soluble in hydrocarbon solvents.

4. The composition of claim 1, wherein said organometallic compound has the formula MetR′ₙ, wherein:
Met is a metal selected from Group IIA, Group IIB, and Group IIIB of the Periodic Table of Elements;
each R′ is independently selected from linear or branched C1-C20 aliphatic hydrocarbons, C2-C20 cycloaliphatic hydrocarbons, C5-C20 aromatic hydrocarbons, and mixtures thereof; and
n is the valence of Met.

5. The composition of claim 4, wherein said organometallic compound has the formula M¹R²⁰R², wherein:
M¹ is an element of Group IIA or Group IIB; and
each R²⁰ and R²¹ is selected from the group consisting of linear or branched C1-C20 aliphatic hydrocarbons, C2-C20 cycloaliphatic hydrocarbons, C5-C20 aromatic hydrocarbons, and mixtures thereof.

6. The composition of claim 5, wherein M¹ is selected from the group consisting of beryllium, magnesium, calcium, strontium, barium, radium, zinc, cadmium, and mercury.

7. The composition of claim 5, wherein M¹ is magnesium.

8. The composition of claim 5, wherein M¹ is zinc.

9. The composition of claim 4, wherein said organometallic compound has the formula M²R²³R²⁴R, wherein:
M² is an element of Group IIIB; and
each R²³, R²⁴, and R²⁵ is selected from the group consisting of linear or branched C1-C20 aliphatic hydrocarbons, C2-C20 cycloaliphatic hydrocarbons, C5-C20 aromatic hydrocarbons, and mixtures thereof.

10. The composition of claim 9, wherein M² is selected from the group consisting of boron, aluminum, gallium, indium, and thallium.

11. The composition of claim 9, wherein M² is aluminum.

12. The composition of claim 1, wherein said organometallic compound is selected from the group consisting of diethylmagnesium, diisopropylmagnesium, dibutylmagnesium, dicyclohexylmagnesium, diphenylmagnesium, diethylzinc, dibutylzinc, diphenyl zinc, triethylaluminum, tripropylaluminum, triisopropylaluminum, tributylaluminum, trioctylaluminum, trimethylboron, triethylboron, and tributylboron and mixtures thereof

13. The composition of claim 1, wherein said alkyllithium compound comprises a compound of the formula RLi wherein R is C1-C12 alkyl or substituted alkyl.

14. The composition of claim 13, wherein said one or more alkyllithium compounds are selected from the group consisting of methyllithium, ethyllithium, n-propyllithium, 2-propyllithium, n-butyllithium, s-butyllithium, t-butyllithium, n-hexyllithium, 2-ethylhexyllithium, 1-octyllithium and mixtures thereof. mixtures thereof.

15. The composition of claim 1, wherein said organometallic compound is present in an amount less than about 10 mol %, based on the amount of alkyllithium species present.

16. The composition of claim 1, wherein said organometallic compound Is present in an amount ranging from about 0.001 mol % to less than about 10 mol %, based on the amount of alkyllithium species present.

17. The composition of claim 1, wherein said organometallic compound is present in an amount ranging from about 1 to about 7 mol %, based on the amount of alkyllithium species present.

18. The composition of claim 1, wherein said composition comprises a hydrocarbon solvent selected from the group consisting of alkanes, cycloalkanes and aromatic solvents and mixtures thereof.

19. An alkyllithium composition having enhanced thermal stability, comprising:
at least one alkyllithium of the formula RLi wherein R is C1-C12 alkyl or substituted alkyl; and
dibutylmagnesium in an amount of less than about 10 mol %, based on the amount of alkyllithium species present, to thermally stabilize said alkyllithium without significantly inhibiting the reactivity of the alkyllithium species.

20. A butyllithium composition having enhanced thermal stability, comprising:
butyllithium; and
dibutylmagnesium in an amount ranging from about 1 to about 7 mol %, based on the amount of alkyllithium species present.

21. A process for preparing alkyllithium compositions having enhanced thermal stability, comprising:
reacting an alkylhalide with lithium to form an alkyllithium composition; and
adding at least one organometallic compound or precursor thereof capable of forming an ate complex with an alkyllithium compound to said composition in an amount sufficient to impart thermal stability to the composition without significantly inhibiting the reactivity of the alkyllithium species, prior to, during or after the synthesis of said alkyllithium.

22. The process of claim 21, wherein said composition has a carbon bound lithium value of at least about 90%, determined using titration, after being stored for 5 days at 40° C.

23. The process of claim 21, wherein said organometallic compound is soluble in hydrocarbon solvents.

24. The process of claim 21, wherein said organometallic compound has the formula MetR′ₙ, wherein:
Met is a metal selected from Group IIA, Group IIB, and Group IIIB of the Periodic Table of Elements;
each R′ is independently selected from linear or branched C1-C20 aliphatic hydrocarbons, C2-C20 cycloaliphatic hydrocarbons, C5-C20 aromatic hydrocarbons, and mixtures thereof; and
n is the valence of Met.

25. The process of claim 24, wherein said organometallic compound has the formula M¹R²⁰R²¹, wherein:
M¹ is an element of Group IIA or Group IIB; and
each R²⁰ and R²¹ is selected from the group consisting of linear or branched C1-C20 aliphatic hydrocarbons, C2-C20 cycloaliphatic hydrocarbons, C5-C20 aromatic hydrocarbons, and mixtures thereof.

26. The process of claim 25, wherein M¹ is selected from the group consisting of beryllium, magnesium, calcium, strontium, barium, radium, zinc, cadmium, and mercury.

27. The process of claim 26, wherein M¹ is magnesium.

28. The process of claim 26, wherein M¹ is zinc.

29. The process of claim 24, wherein said organometallic compound has the formula M²R²³R²⁴R²⁵, wherein:
M² is an element of Group IIIB; and
each R²³, R²⁴, and R²⁵ is selected from the group consisting of linear or branched C1-C20 aliphatic hydrocarbons, C2-C20 cycloaliphatic hydrocarbons, C5-C20 aromatic hydrocarbons, and mixtures thereof.

30. The process of claim 29, wherein M² is selected from the group consisting of boron, aluminum, gallium, indium, and thallium.

31. The process of claim 30, wherein M² is aluminum.

32. The process of claim 21, wherein said organometallic compound is selected from the group consisting of diethylmagnesium, diisopropylmagnesium, dibutylmagnesium, dicyclohexylmagnesium, diphenylmagnesium, diethylzinc, dibutylzinc, diphenyl zinc, triethylaluminum, tripropylaluminum, triisopropylaluminum, tributylaluminum, trioctylaluminum, trimethylboron, triethylboron, and tributylboron and mixtures thereof.

33. The process of claim 21, wherein said alkyllithium compound comprises a compound of the formula RLi wherein R is C1-C12 alkyl or substituted alkyl.

34. The process of claim 21, wherein said one or more alkyllithium compounds are selected from the group consisting of methyllithium, ethyllithium, n-propyllithium, 2-propyllithium, n-butyllithium, s-butyllithium, t-butyllithium, n-hexyllithium, 2-ethylhexyllithium, 1-octyllithium and mixtures thereof.

35. The process of claim 21, wherein said adding step comprises adding said organometallic compound or precursor thereof in an amount in an amount less than about 10 mol %, based on the amount of alkyllithium species present.

36. The process of claim 21, wherein said adding step comprises adding said organometallic compound or precursor thereof in an amount ranging from about 0.001 mol % to less than about 10 mol %, based on the amount of alkyllithium species present.

37. The process of claim 21, wherein said adding step comprises adding said organometallic compound or precursor thereof in an amount ranging from about 1 to about 7 mol %, based on the amount of alkyllithium species present.

38. The process of claim 21, wherein said composition comprises a hydrocarbon solvent selected from the group consisting of alkanes, cycloalkanes and aromatic solvents and mixtures thereof.

39. The process of claim 21, further comprising adding said alkylhalide to a reactor prior to said reacting step.

40. The process of claim 39, wherein said adding step comprises adding the organometallic compound or a precursor thereof to the same reactor prior to adding the alkylhalide to the reactor.

41. The process of claim 39, wherein said adding step comprises adding the organometallic compound or a precursor thereof to the same reactor substantially simultaneously with adding the alkylhalide to the reactor.

42. The process of Claim 1, wherein said adding step comprises mixing said organometallic compound or a precursor thereof with said alkylhalide to form an alkylhalide/organometallic compound or precursor mixture and adding said mixture to the reactor.

43. The process of claim 39, wherein said adding step comprises adding the organometallic compound or a precursor thereof to the same reactor after adding the alkylhalide to the reactor.

44. The process of claim 21, wherein said adding step comprises adding said organometallic compound or a precursor thereof to a lithium dispersion prior to said reacting step.

45. The process of claim 21, wherein said adding step comprises adding said organometallic compound or a precursor thereof to said composition during said reacting step.

46. The process of claim 21, wherein said adding step comprises adding said organometallic compound or a precursor thereof to said composition after said reacting step.

47. The process of claim 21, wherein said adding step comprises adding an organometallic precursor to a reactor prior to said reacting step, and wherein said organometallic precursor comprises a reactive elemental metal.

48. The process of claim 21, wherein said adding step comprises adding an organometallic precursor to said composition after said reacting step, and wherein said organometallic precursor comprises a metal halide or alkoxide.

49. The process of claim 21, further comprising filtering said composition after said reacting step.

50. A process for preparing alkyllithium compositions having enhanced thermal stability, comprising:
reacting an alkylhalide of the formula RX wherein R is C1-C12 alkyl or substituted alkyl and X is halide with lithium to form an alkyllithium composition of the formula RLi; and
adding dibutylmagnesium or a precursor thereof to said composition prior to, during or after the synthesis of said alkyllithium in an amount less than about 10 mol %, based on the amount of alkyllithium species present, to thermally stabilize said alkyllithium without significantly inhibiting the reactivity of the alkyllithium species.

51. A process for preparing butyllithium compositions having enhanced thermal stability, comprising:
reacting butylhalide with lithium to form a butyllithium composition; and
adding dibutylmagnesium or a precursor thereof to said composition prior to, during or after the synthesis of said butyllithium in an amount ranging from about 1 to about 7 mol %, based on the amount of alkyllithium species present.
